(19) United States
(12) Patent Application Publication
(10) Pub. No.: US 2019/0184424 A1
(43) Pub. Date: Jun. 20, 2019

(54) VIBRATION GENERATING DEVICE

(71) Applicant: NIDEC SANKYO CORPORATION, Nagano (JP)

(72) Inventors: Tadashi TAKEDA, Nagano (JP); Hiroshi KITAHARA, Nagano (JP); Masao TSUCHIHASHI, Nagano (JP)

(73) Assignee: NIDEC SANKYO CORPORATION, Nagano (JP)

(21) Appl. No.: 16/322,123

(22) PCT Filed: Aug. 3, 2017
(86) PCT No.: PCT/JP2017/028229

§ 371 Date: Jan. 31, 2019

(30) Foreign Application Priority Data
Aug. 9, 2016 (JP) 2016-156897

(51) Int. Cl. B06B 1/04; H02K 33/00; H02K 1/34

(52) U.S. Cl. CPC B06B 1/045; H02K 5/04; H02K 1/34; H02K 33/00

(57) ABSTRACT

A vibration generating device that can make a relatively heavy vibration member produce sufficient vibration. A vibration generating device has: a vibration member; multiple actuators that are connected to the vibration member; and a stationary element that supports the vibration member via the multiple actuators. Each of the multiple actuators comprises: a supporting body to which the vibration member is fixed; a movable element; a first elastic member that is connected to the supporting body and the movable element; and a magnetic drive circuit (a first magnetic drive circuit and a second magnetic drive circuit) that makes the movable element move linearly back and forth relative to the supporting body. The multiple actuators are supported by the stationary element via a second elastic member. The first elastic member and the second elastic member comprise a gelatinous silicone gel or the like.

### TECHNICAL FIELD

The present invention relates to a vibration generating device that generates various kinds of vibrations.

### BACKGROUND ART

As an actuator that causes a user to perceive vibrations, a configuration has been proposed in which a magnetic drive mechanism having cylindrical coils and cylindrical magnets around a movable element is provided to vibrate the movable element in an axial direction (Patent Reference 1, 2).

### CITATION LIST

### Patent Literature

Patent reference 1: Japanese Unexamined Patent Application Publication 2002-78310

Patent reference 2: Japanese Unexamined Patent Application Publication 2006-7161

### SUMMARY

### Technical Problems

In the configurations disclosed in Patent Reference 1 and 2, however, sufficient vibration cannot be output when a relatively heavy vibration member is vibrated.

In consideration of the problem mentioned above, an object of the present invention is to provide a vibration generating device capable of sufficiently vibrating a relatively heavy vibration member.

### Solutions to Problems

In order to solve the problem mentioned above, a vibration generating device of the present invention comprises a vibration member, multiple actuators connected to the vibration member, and a stationary element which supports the vibration member via the multiple actuators. Each of the multiple actuators includes: a supporting body to which the vibration member is fixed, a movable element, a first elastic member which has at least one of elasticity and viscoelasticity and is connected to the supporting body and the movable element, and a magnetic drive circuit which is configured to move the movable element linearly back and forth with respect to the supporting body.

In the present invention, when the movable element is linearly moved back and forth by the magnetic drive circuit, the position of the center of gravity of the actuator shifts and then vibration is output. Also, in this embodiment, the supporting bodies used in the multiple actuators are fixed to a common vibration member; therefore, vibrations generated by the multiple actuators are transmitted to the common vibration member. Therefore, even when the vibration member is relatively heavy, it can be vibrated with large amplitude. Since vibrations generated by the multiple actuators are transmitted to the common vibration member, different vibrations can be caused among the multiple actuators so that the common vibration member outputs various kinds of vibrations.

The present invention may adopt a configuration in which each of the multiple actuators has, as the magnetic drive circuit, a first magnetic drive circuit, which moves the movable element linearly back and forth with respect to the supporting body in a first direction, and a second magnetic drive circuit, which moves the movable element linearly back and forth with respect to the supporting body in a second direction crossing the first direction. According to this configuration, by causing different vibrations among the multiple actuators, the common vibration member can output various kinds of vibrations.

The present invention may adopt a configuration in which the vibration member is a plate member which extends in the first direction and in the second direction. According to this configuration, the vibration generating device can be made thinner. Also, even when the area of the vibration member is widened to increase the number of actuators which can be connected to the vibration member, vibrations with large amplitude can be output since the mass of the vibration member is small.

The present invention may adopt a configuration in which at least three actuators of the multiple actuators are arranged to appear to be around a center position of the vibration member when viewed from a third direction, which perpendicularly intersects with the first direction and the second direction. According to this configuration, vibrations generated by the multiple actuators can be efficiently transmitted to the common vibration member; also, by causing different vibrations among the multiple actuators, the common vibration member can generate various kinds of vibrations.

The present invention may adopt a configuration in which the multiple actuators are arranged point symmetric about the center position of the vibration member, or the multiple actuators are arranged line symmetric with respect to an imaginary line passing the center position. According to this configuration, vibrations generated by the multiple actuators can be efficiently output from the common vibration member; also, by causing different vibrations among the multiple actuators, the common vibration member can output various kinds of vibrations.

The present invention may adopt a configuration in which the multiple actuators generate vibrations in different directions. For example, some actuators among the multiple actuators, which are opposed to each other about the center position, generate vibrations which have opposite directionalities around the center position. According to this configuration, the common vibration member can output vibrations with either directionality around the center position.

The present invention may adopt a configuration in which the multiple actuators are supported to the stationary element via a second elastic member which are provided with at least one of elasticity and viscoelasticity. According to this configuration, the vibrations output from the multiple actuators are prevented from causing the actuators to resonate.

### Effects of Invention

In this embodiment, when the movable element is moved linearly back and forth by the magnetic drive circuit in each of the multiple actuators, the center of gravity of each actuator shifts and then vibrations are output. Also, since the supporting bodies used in the multiple actuators are fixed to the common vibration member, vibrations generated by the multiple actuators are transmitted to the common vibration member. Therefore, even if the vibration member is relatively heavy, vibrations with large amplitude can be generated. Also, vibrations generated by the multiple actuators are transmitted to the common vibration member; therefore, if the multiple actuators are caused to generate different vibrations from each other, the common vibration member can output various kinds of vibrations.

### BRIEF DESCRIPTION OF THE DRAWINGS

FIG. 1 are explanatory diagrams of a vibration generating device to which the present invention is applied.

FIG. 2 is a perspective view of an actuator used in the vibration generating device to which the present invention is applied.

FIG. 3 are cross-sectional views of the actuator shown in FIG. 2.

FIG. 4 is a perspective exploded view of the actuator shown in FIG. 2.

FIG. 5 is a perspective exploded view of a major part of the actuator shown in FIG. 2.

FIG. 6 is a perspective exploded view of the major part of the actuator shown in FIG. 2, in which some of magnets and coils are removed from a movable element and a supporting body.

FIG. 7 is an explanatory diagram of an example of another layout of the actuator in the vibration generating device to which the present invention is applied.

### DESCRIPTION OF EMBODIMENTS

Referring to the drawings, an embodiment of the present invention is described. Note that, for the purpose of clarifying the layout of a vibration generating device 100 and actuators 1 in the description below, the directions crossing each other are given as an X-axis direction, an Y-axis direction and a Z-axis direction; X1 is given to one side in the X-axis direction, X2 is given to the other side in the X-axis direction, Y1 is given to one side in the Y-axis direction, Y2 is given to other side in the Y-axis direction, Z1 is given to one side in the Z-axis direction and Z2 is given to the other side in the Z-axis direction. In the vibration generating device 100 or the actuators 1, a drive force is generated by a magnetic drive circuit in either a first direction L1 or a second direction L2. Here, the first direction L1 extends along the X-axis direction; the second direction L2 extends along the Y-axis direction; a third direction L3 crossing the first direction L1 and the second direction L2 extends along the Z-axis direction.

(Configuration of Vibration Generating Device 100)

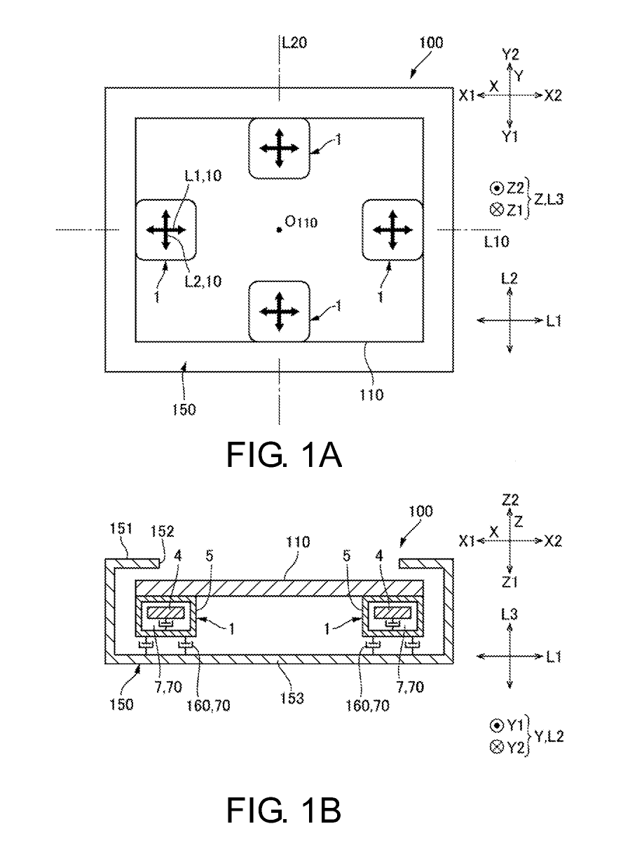

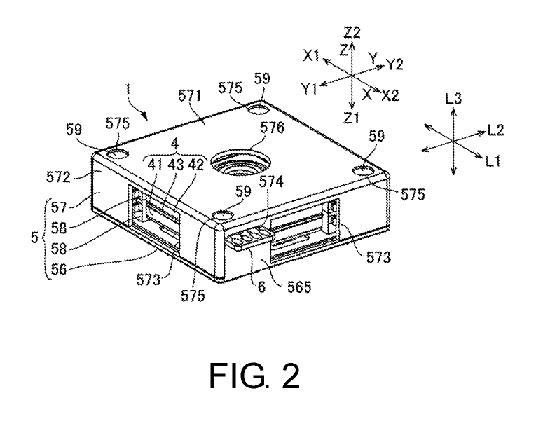

FIG. 1 shows explanatory diagrams of the vibration generating device 100 to which the present invention is applied: FIGS. 1 (a) and (b) are respectively a plan view of the vibration generating device 100 and a cross-sectional view of the vibration generating device 100. Note that, in FIG. 1 (a), the illustration of a top part of a stationary element is omitted so the internal configuration of the vibration generating device 100 can be easily understood. In FIG. 1 (a), also, fat arrows indicate directions of vibrations generated by each of the actuators; in FIG. 2, arrows L1 and L2 indicate the directions of vibrations caused by the magnetic drive circuits (a first magnetic drive circuit 10 and a second magnetic drive circuit 20) in each actuator 1.

In FIG. 1, the vibration generating device 100 to which the present invention is applied comprises a vibration member 110, multiple actuators 1 connected to the vibration member 110, and a stationary element 150 for supporting the vibration member 110 via the multiple actuators 1. The stationary element 150 is a casing which stores the vibration member 110 and the multiple actuators 1 therein; an opening portion 152 is created in an end plate 151 positioned on the other side Z2 in the Z-axis direction so that the vibration member 110 is exposed to the other side Z2 in the Z-axis direction.

Each of the multiple actuators 1 is provided with a supporting body 5 to which the vibration body 110 is fixed, a movable element 4, a first elastic member 7 having at least elasticity or viscoelasticity, and magnetic drive circuits (a first magnetic drive circuit 10 and a second magnetic drive circuit 20) which cause the movable element 4 to move linearly back and forth with respect to the supporting body 5; the first elastic member 7 is connected to the supporting body 5 and the movable element 4. The first elastic member 7 is, for example, a viscoelastic body such as a gel-based damper member which is described later.

Between each of the multiple actuators 1 and a bottom portion 153 of the stationary element 150, a second elastic member 160 having at least elasticity or viscoelasticity is arranged; the stationary element 150 supports each of the multiple actuators 1 via the second elastic member 160. The second elastic member 160 is a viscoelastic body such as a gel-based damper member, which is described later, in the same manner as the first elastic member 7.

In each of the multiple actuators 1, the first magnetic drive circuit 10 causes the movable element 4 to move linearly back and forth in the first direction L1 along the X-axis direction with respect to the supporting body 5; the second magnetic drive circuit 20 causes the movable element 4 to move linearly back and forth in the second direction L2 along the Y-axis direction with respect to the supporting body 5.

The vibration member 110 is a plate member which extends in the first direction L1 (the X-axis direction) and the second direction L2 (the Y-axis direction); the multiple actuators 1 are respectively connected to the surface of the vibration member 110 on the other side Z2 in the Z-axis direction. In this embodiment, the multiple actuators 1 are arranged such that at least three of them are placed around the center position O110 of the vibration member 110.

The planar shape of the vibration member 110 is a quadrangle. More specifically, the planar shape of the vibration member 110 is a rectangle and each of four actuators 1 is arranged around the center of each of four sides of the vibration member 110. Therefore, the multiple actuators appear point symmetric about the center position O110 of the vibration member 110 when viewed from the third direction L3. Also, the multiple actuators are arranged line symmetric with respect to a first imaginary line L10, which passes through the center position O110 of the vibration member 110 and extends in the first direction L1 (the X-axis direction), and also line symmetric with respect to a second imaginary line L20, which passes through the center position O110 of the vibration member 110 and extends in the second direction L2 (the Y-axis direction).

(Operation at Vibration Generating Device)

In the vibration generating device 100 configured as above, when the movable element 4 is vibrated in each of the multiple actuators 1, vibrations are transmitted from each of the movable bodies 4 to the vibration member 110. As a result of this, information is sent through vibrations to a user who is holding the vibration generating device 100. For example, the vibration generating device 100 is built in a cell phone, etc. to notify the user of incoming calls/emails. The vibration generating device 100 can also be used for an operation member for a game machine, providing new sensation through vibrations.

More specifically described, when the movable element 4 in every actuator 1 is vibrated in the first direction L1, the vibration member 110 will be vibrated in the first direction L1; therefore, the vibrations in the first direction L1 are output from the vibration generating device 100. On the other hand, when the movable element 4 in every actuator 1 is vibrated in the second direction L2, the vibration member 110 will be vibrated in the second direction L2; therefore, the vibrations in the second direction L2 are output from the vibration generating device 100. At that time, if the speed of the movable element 4 moving back and forth is differentiated on one side from the other side, vibrations having directionality can be generated in the actuator 1. Therefore, actuators among the multiple actuators 1, which are opposed to each other about the center position O110, may generate vibrations having opposite directionalities from each other around the center position O110. Even more specifically described, two actuators 1 which are opposed in the second direction L2 may generate vibrations having opposite directionalities from each other in the first direction L1 while two other actuators 1 which are opposed in the first direction L1 may generate vibrations having opposite directionalities from each other in the second direction L2; it may be set so that the directionalities of the vibrations generated by the four actuators 1 move in one way in the circumferential direction. In this case, the vibration member 110 generates vibrations having a directionality in one way around the center position O110. Therefore, vibrations having a directionality in one way around the center position O110 are output from the vibration generating device 100.

(Overall Configuration of Actuator 1)

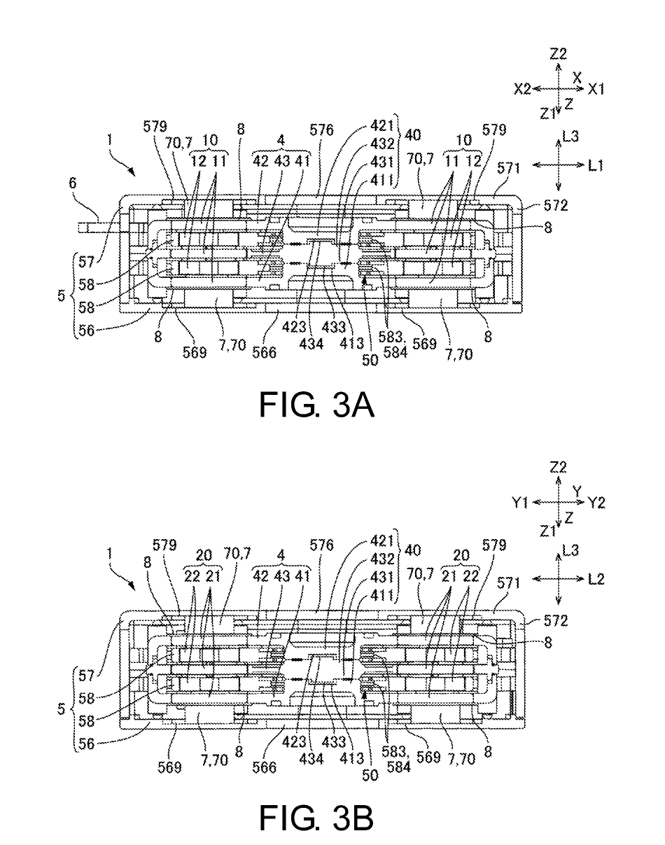

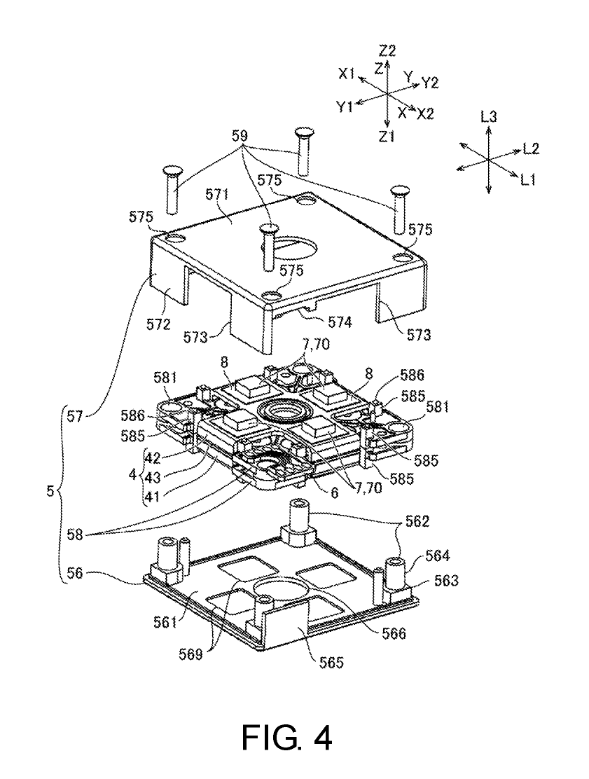

FIG. 2 is a perspective view of the actuator 1 used in the vibration generating device 100 to which the present invention is applied. FIG. 3 shows cross-sectional views of the actuator 1 shown in FIG. 2; FIGS. 3 (a) and (b) are respectively an XZ cross-sectional view taken along a line passing through the center portion of the actuator 1 and a YZ cross-sectional view taken along a line passing the center portion of the actuator 1. FIG. 4 is an exploded perspective view of the actuator 1 shown in FIG. 2.

In FIG. 2, FIG. 3 and FIG. 4, the first magnetic drive circuit 10 in an actuator 1 has first coils 12 held to the supporting body 5 and first magnets 11 held to the movable element 4; the first magnets 11 and the first coils 12 are opposed to each other in the Z-axis direction (the third direction L3). The second magnetic drive circuit 20 has second coils 22 held to the supporting body 5 and second magnets 21 held to the movable element 4; the second magnets 21 and the second coils 22 are opposed to each other in the Z-axis direction (the third direction L3). The first magnetic drive circuit 10 generates a drive force in the first direction L1 which is the X-axis direction; the second magnetic drive circuit 20 generates a drive force in the second direction L2 which is the Y-axis direction. Here, the first magnets 11 and the first coils 12 are arranged at two places which are opposed in the first direction L1. Likewise, the second magnets 21 and the second coils 22 are arranged at two places which are opposed in the second direction L2. In other words, the second magnetic drive circuit 20 is arranged at two places which are opposed in the second direction L2.

(Configuration of Supporting Body 5)

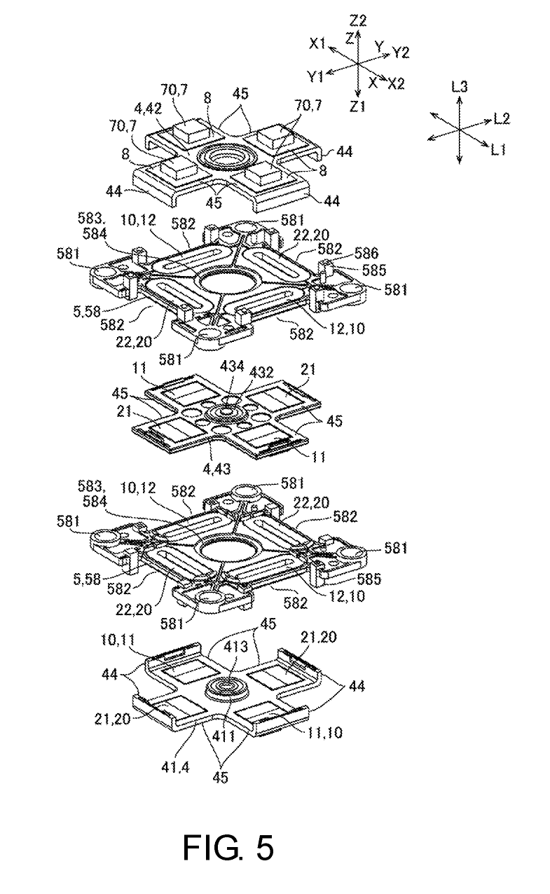

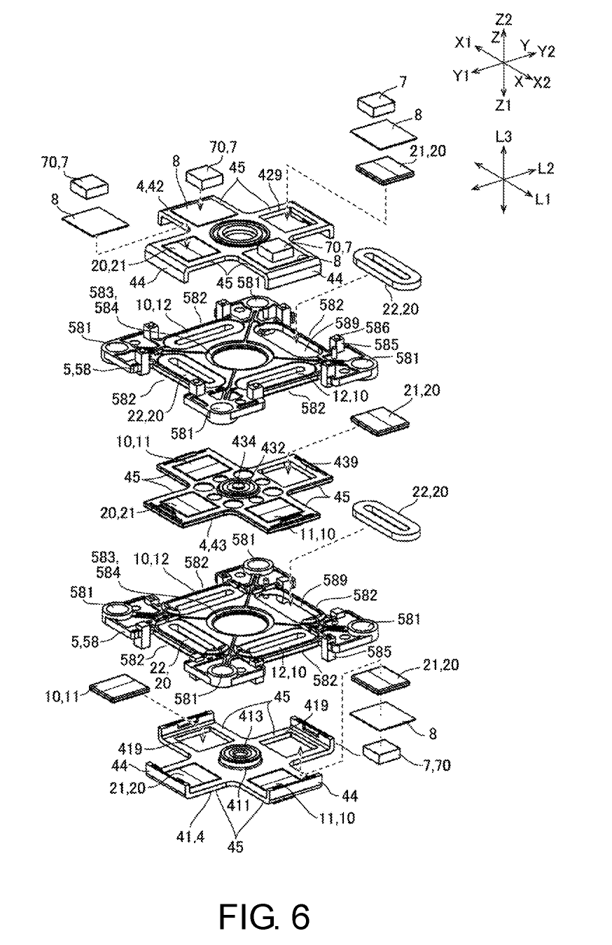

FIG. 5 is a perspective view of an exploded major part of the actuator 1 shown in FIG. 2. FIG. 6 is a perspective view of the exploded major part of the actuator 1 shown in FIG. 2, in which some of the magnets and coils are removed from the movable element 4 and the supporting body 5.

The supporting body 5 has a first casing 56 positioned on one side Z1 in the X-axis direction, a second casing 57 covering the first casing 56 from the other side Z2 in the Z-axis direction, and a holder 58 (a holder in the supporting body) arranged between the first casing 56 and the second casing 57; the first casing 56 and the second casing 57 are fixed together by four fixing screws, interposing the holder 58 between them.

The second casing 57 has an end plate portion 571 having a square planar shape when viewed in the Z-axis direction and four side plate portions 572, each of which protrudes from the edge of each end plate portion 571. In the end plate portion 571, a circular hole 576 is created in the center and a fixing hole 575 is created at four corners. In the center portion of each of the four side plate portions 572, a notch portion 573 is formed by cutting from one side Z1 to the other side Z2 in the X-axis direction. In the side plate 572 on the other side X2 in the Z-direction, a notch portion 574 is created by cutting the portion next to the notch portion 573 by a partial height in the Z-direction.

The first casing 56 is provided with an end plate portion 561 having a square planar shape when viewed from the Z-axis direction and a boss portion 562 protruding from each of the four corners of the end plate portion 561 toward the end plate portion 571 of the second casing 57. In the center of the end plate portion 561, a circular hole 566 is created. The boss portion 562 is provided with a step surface 563 formed part of the way in the Z-axis direction and a cylindrical portion 564 protruded from the step surface 563 toward the other side Z2 in the Z-axis direction. Therefore, by screwing the fixing screws 59 to the bosses 562 of the first casing 56 through the fixing holes 575 of the second casing 57 from the other side Z2 in the Z-axis direction, the end plate portion 571 of the first casing 56 is fixed to the edge on one side Z1 in the Z-axis direction of the side plate portions 572. The first casing 56 is provided with a rising portion 565 which is to be opposed to the notch portion 574 of the second casing 57 in the first direction L1; the rising portion 565 configures with the notch portion 574 a slit which is used to position a base board 26. Connected to the base board 26 are a feeder [to supply power] to the first coils 12 and the second coils 22.

As shown in FIG. 3, FIG. 5 and FIG. 6, two holders 58 are layered in the Z-axis direction between the first casing 56 and the second casing 57. The basic configurations of the two holders 58 are shared, and a hole 583 is formed in the center of each holder 58. In this embodiment, the hole 583 is circular. Circular holes 581 are formed at four corners of each of the two holders 58; the cylindrical portions 564 of the bosses 562 are inserted in the circular holes 581 and the holders 58 are positioned and held at the step surfaces 563. In the center of each of the four sides of the holder 58, a recess portion 582 is indented toward the inner circumference.

Plate members of the same configuration are inverted in the Z-axis direction to configure the two holders 58. Therefore, column-like protrusions 585 protrude from the holder 58, which is arranged on the one side Z1 in the Z-axis direction, toward the first casing 56 while multiple column-like protrusions 585 protrude from the other holder 58, arranged on the other side Z2 in the Z-axis direction, toward the second casing 57. Also, a spherical contact portion 586 is formed at a tip end of each of the multiple column-like protrusions 585. Therefore, as the first casing 56 and the second casing 57 are fixed by the fixing screw 59 interposing the holders 58 between them, the positioning of the first casing 56, the two holders 58 and the second casing 57 in the Z-axis direction is determined with certainty.

(Arrangement of First Coil 12 and Second Coil 22)

In each of the two holders 58, an elongated through hole 589 is formed at four places between the recess portions 582 and the hole 583. In each of the two holders 58, a first coil 12 of the first magnetic drive circuit 10 are held inside the two through holes 589 which are opposed in the first direction L1. Also, in each of the two holders 58, a second coil 22 of the second magnetic drive circuit 20 is held inside the two through holes 589 which are opposed in the second direction L2. Therefore, each of the two holders 58 holds the first coils and the second coils 22 in one layer in the Z-axis direction, and the first coils 12 and the second coils 22 are respectively layered in the Z-axis direction in the supporting body 5. The first coil 12 is a flat coreless coil having a long side, which is an effective side, in the Y-axis direction; the second coil 22 is also a flat coreless coil having a long side, which is its effective side, in the X-axis direction.

(Configuration of Movable Element 4)

The movable element 4 has a sheet-like first holder 41 (a holder for a movable element) which is positioned on one side Z1 in the Z-axis direction of the two holders 58, a sheet-like second holder 42 (a holder for a movable element) which is positioned on the other side Z2 in the Z-axis direction of the two holders 58, and a sheet-like third holder 43 (a holder for a movable element) which is positioned between the two holders 58. The first holder 41, the second holder 42 and the third holder 43 respectively have four protrusion portions 45 which protrude to both sides in the X-axis direction and in the Y-axis direction to appear as in a +(plus) shape when viewed in the Z-axis direction. The tip end portion of each protrusion portion 45 formed to the first holder 41 is formed as a joint part 44 which is bent to the other side Z2 in the Z-axis direction, and the tip end portion of each protrusion portion 45 formed to the second holder 42 is formed as a joint part 44 which is bent to one side Z1 in the Z-axis direction. Therefore, when the first holder 41, the second holder 42 and the third holder are assembled together in layers, the tip end portion of each protrusion portion 45 of the first holder 41 contacts the tip end portion of the corresponding protrusion portion 45 of the second holder 42 and the third holder 43. By joining the corresponding tip end portions of the protrusion portions 45 of the first holder 41, the second holder 42 and the third holder 43 by a method of adhesive or welding, the first holder 41, the second holder 42 and the third holder 43 are joined together.

(Arrangement of First Magnet 11 and Second Magnet 21)

The first holder 41, the second holder 42 and the third holder 43 respectively each have a rectangular through hole 419, 429 and 439 formed in each of the four protrusion portions 45 which protrude to both sides in the X-axis direction and in the Y-axis direction. First magnets 11 of the first magnetic drive circuit 10 are held in the through holes 419, 429 and 439 of the two protrusion portions 45 which are opposed in the X-axis direction. Also, second magnets 21 of the second magnetic drive circuit 20 are held in the through holes 419, 429 and 439 in the two protrusion portions 45 which are opposed in the Y-axis direction. Therefore, the first holder 41, the second holder 42 and the third holder 43 respectively hold the first magnets 11 and the second magnets 21 in one layer in the Z-axis direction.

As described, the multiple first coils 12 are arranged in layers in the Z-axis direction, and the first magnets 11 are arranged at both sides in the Z-axis direction of each of the first coils 12 of the first magnetic drive circuit 10. Also, the multiple second coils 22 are arranged in layers in the Z-axis direction and the second magnets 21 are arranged at both sides in the Z-axis direction of each of the multiple second coils 22 of the second magnetic drive circuit 20. In this embodiment, the first coils 12 and the second coils 22 are arranged in two layers in the Z-axis direction, and the first magnets and the second magnets 21 are arranged at both sides in the Z-axis direction of each of the multiple first coils and the second coils 22 in each layer. The first magnet 11 is a sheet magnet, of which the magnetizing and polarizing line extends in the Y-axis direction; the second magnet 21 is also a sheet magnet, of which the magnetizing and polarizing line extends in the X-axis direction.

A back yoke 8 is layered on one side Z1 in the Z-axis direction of each of the first magnets 11 and the second magnets 21 held in the first holder 41. Also, a back yoke 8 is layered on the other side Z2 in the Z-axis direction of each of the first magnets 11 and the second magnets 21 held in the second holder 42. The back yoke 8 is larger than the first magnet 11 or the second magnet 21 (the size of the through hole 419, 429) in size and fixed to the first holder 41 or the second holder 42 by a method of adhesive, etc.

(Configuration of Elastic Member 7)

Between the back yoke 8 provided to the first holder 41 and the end plate portion 561 of the first casing 56, an elastic member 7 which contacts the back yoke 8 and the first casing 56 is provided at four positions [where the yokes are]. Between the back yoke 8 provided to the second holder 42 and the end plate portion 571 of the second casing 57, an elastic member 7 which contacts the back yoke 8 and the second casing 57 is provided at four positions [where the yokes are].

In this embodiment, the elastic member 7, a viscoelastic body, is composed of a gel-based damper member 70 and is arranged between the movable element 4 and the supporting body 5. In this embodiment, the gel-based damper member 70 is a silicone gel sheet. The planar shape of the elastic member 7 is in a polygon such as a rectangle; the portion of the end plate portion 561 of the first cover 56 and the portion of the end plate portion 571 of the second cover 57 in which the elastic members 7 are positioned are made as recess portions 569 and 579 (FIG. 3). Viscoelasticity has characteristics of both viscosity and elasticity, which are remarkably found in a polymer substance such as a gel-based member, a plastic, a rubber, etc. Therefore, various kinds of gel-based members can be adopted for the elastic member 7 (the viscoelastic body). Also, the gel-based damper member 70 (the viscoelastic body) may use various rubber materials and their modified materials such as natural rubber, diene-based rubber (such as styrene butadiene rubber, isoprene rubber or butadiene rubber), chloroprene rubber, acrylonitrile butadiene rubber, etc.) non-diene-based rubber (such as butyl rubber, ethylene propylene rubber, ethylene propylene diene rubber, urethane rubber, silicone rubber, fluororubber, etc.) or thermoplastic elastomer, etc.

The gel-based damper member 70 has viscoelasticity and has linear or nonlinear stretch characteristics according to its stretch direction. For example, a sheet gel-based damper member 70 demonstrates the stretch characteristics in which a nonlinear component (a spring constant) is larger than a linear component (a spring constant) when pressed and compressively deformed in its thickness direction (the axial direction). On the other hand, when pulled and stretched in the thickness direction (the axial direction), it demonstrates the stretch characteristics in which a linear component (a spring constant) is larger than a nonlinear component (a spring constant). Because of this, when the sheet gel-based damper member 70 is pressed and compressively deformed in the thickness direction (in the axial direction) between the movable element 4 and the supporting body 5, it is prevented from being significantly deformed; therefore, the gap between the movable element 4 and the supporting body 5 is prevented from changing significantly. On the other hand, when the sheet gel-based damper member 70 is deformed in the direction (the sheering direction) crossing the thickness direction (the axial direction), the deformation is in the direction the elastic member 7 is pulled and stretched no matter which direction it moves; therefore, it demonstrates the deformation characteristics in which a linear component (a spring constant) is larger than a nonlinear component (a spring constant). Therefore, a spring force by a moving direction is constant in the sheet-like gel-based damper member 70 (the viscoelastic body). Therefore, by using the spring element in the sheering direction of the sheet-like gel-based damper member 70 (the viscoelastic body), the reproducibility of vibratory acceleration to the input signals can be improved, enabling it to produce vibrations with delicate nuance. In this embodiment, the gel-based damper member 70 is composed of a column-like (sheet-like) silicone gel with penetration of 10° to 110°. In this embodiment, the gel-based damper member 70 is composed of a quadrangular prism-shaped (sheet-like) silicone gel. It is composed of a silicone-based gel with penetration of 10° to 110°. Penetration is defined by JIS-K-2227 or JIS-K-2220, where the smaller the value is the harder the material is. Note that, in this embodiment, the second elastic member 160 which is described referring to FIG. 1 is also a gel-based damper member 70 in the same manner as the first elastic member 7.

(Configuration of Stopper Mechanism 50)

As shown in FIG. 3, etc., in the center of the first holder 41, a protruded coupling portion 411 having a smaller outside diameter than the hole 583 in the holder 58 protrudes to the other side Z2 in the Z-axis direction; in the center of the second holder 42, a protruded coupling portion 421 having a smaller outside diameter than the hole 583 in the holder 58 protrudes to one side Z1 in the Z-axis direction. In the center of the third holder 43, a protruded coupling portion 431 having a smaller outside diameter than the hole 583 of the holder 58 protrudes to one side Z1 in the Z-axis direction and a protruded joint portion 432 having a smaller outside diameter than the hole 583 in the holder 58 protrudes to the other side Z2 in the Z-axis direction. The protruded coupling portion 431 in the third holder 43 is in contact with the protruded coupling portion 411 of the first holder 41 inside the hole 583 of the holder 58. The protruded joint portion 432 in the third holder 43 is in contact with the protruded coupling portion 421 of the second holder 42 inside the hole 583 of the holder 58. At the tip end portions of the protruded coupling portions in the third holder 43, positioning protrusion portions 433 and 434 are respectively formed; at the tip end portions of the protruded coupling portions 411 and 421, recess portions 413 and 423 are respectively formed for the protruded portions 433 and 434 to fit into. Also, the protruded coupling portion 431 in the third holder 43 is coupled with the protruded coupling portion 411 in the first holder 41 by an adhesive, etc.; the protruded coupling portion 432 in the third holder 43 is coupled with the protruded coupling portion 421 in the second holder 42 by an adhesive, etc. Therefore, the first holder 41, the second holder 42 and the third holder 43 are connected to each other at a body portion, which consists of the protruded coupling portions 411, 431, 432 and 421, inside the hole 583 of the holder 58.

Consequently, a wall portion 584 on the inside of the hole 583 of the holder 58 which is provided to the supporting body 5 surrounds the circumferential surface of the body portion 40 provided to the movable element 4 to configure a stopper mechanism 50 which restricts the movable range of the movable element 4 in the direction perpendicular to the Z-axis direction.

(Operation at Actuator 1)

In the actuator 1 of this embodiment, the first coils 12 of the first magnetic drive circuit 10 are electrified with alternating current to vibrate the movable element 4 in the third direction L1 which is the X-axis direction. The second coils 22 of the second magnetic drive circuit 20 are electrified with alternating current to vibrate the movable element 4 in the second direction L2 which is the Y-axis direction. At that time, the center of gravity in the actuator 1 shifts in the first direction L1 and in the second direction L2; therefore, the vibration member 110, which is described referring to FIG. 1, vibrates in the first direction L1 and in the second direction L2. Therefore, a user can perceive the vibrations in the first direction L1 and the vibrations in the second direction L2. Also, if the alternate current waveform applied to the first coils 12 is adjusted to differentiate the speed at which the movable element 4 moves toward one side in the first direction L1 from the speed at which the movable element 4 moves toward the other side in the first direction, a user can perceive vibrations having a directionality in the first direction L1. In the same manner, if the alternate current waveform applied to the second coils 22 is adjusted to differentiate the speed of the movable element 4 moving toward one side in the second direction L2 from its speed moving toward the other side in the second direction L2, a user can perceive vibrations having a directionality in the second direction L2.

In the first magnetic drive circuit 10 and the second magnetic drive circuit 20, the first coils 12 and the first magnets 11 are opposed to each other in the Z-axis direction (the third direction L3), and the second coils 22 and the second magnets 21 are opposed to each other in the Z-axis direction (the third direction L3). Therefore, even when both the first magnetic drive circuit 10 and the second magnetic drive circuit 20 are provided, the dimension of the actuator 1 in the Z-axis direction can be kept relatively small. For this reason, in the first magnetic drive circuit 10 and the second magnetic drive circuit 20, the first coils 12 and the second coils 22 are arranged in two layers in the Z-axis direction and the first magnets 11 and the second magnets 21 are arranged at both sides in the Z-axis direction of each of the first coils 12 and the second coils 22 in each layer to increase the strength of the first magnet drive circuit 10 and the second magnet drive circuit 20; even in this case, the dimension of the actuator 1 in the Z-axis direction can be kept relatively small. Since the first magnets 11 and the second magnets 21 are arranged at both sides in the third direction L3 of each of the first coils 12 and the second coils 22 in each layer, there is less magnetic flux leakage, compared to the case in which the magnet is opposed to only one surface of the coil. Therefore, the thrust to move the movable element 4 can be increased.

The first magnetic drive circuits 10 are provided at two places in each layer which are opposed in the X-axis direction and the circuits 10 in two layers are aligned with each other when viewed in the Z-axis direction. Also, the second magnetic drive circuits 20 are provided at two places in each layer which are opposed in the Y-axis direction and the circuits 20 in two layers are aligned with each other when viewed in the Z-axis direction. For this reason, when the first magnetic drive circuits 10 and the second magnetic drive circuits 20 are driven to vibrate the movable element 4 in the first direction L1 and the second direction L2, the movable element 4 is not easily rotated around the axial direction extending in the Z-axis direction; therefore, the movable element 4 can efficiently be vibrated.

Also, in this embodiment, a stopper mechanism 50 which restricts the movable range of the movable element 4 in the direction orthogonally intersecting with the Z-axis direction is provided, utilizing [the space] between the first magnetic drive circuits 10 which are opposed to each other in the first direction L1 and [the space] between the second magnetic drive circuits 20 which are opposed to each other in the second direction L2. When the movable element 4 vibrates in the first direction L1 and in the second direction L2, the first elastic member 7 (the gel-based damper member 70) deforms in the sheering direction; however, because of [the function of the stopper mechanism 50], the movable range of the movable element 4 can be less than the maximum deformation amount in the sheering direction of the gel-based damper member 70. Therefore, even if the movable element 4 vibrates at maximum, the gel-based damper member 70 won't stretch more than the maximum deformation amount; therefore, damage to the gel-based damper member 70 can be avoided. Also, the stopper mechanism 50 is provided utilizing the space between the first magnetic drive circuits 10, which are opposed to each other in the first direction L1, and the space between the second magnetic drive circuits 20, which are opposed to each other in the second direction L2; therefore, even when the stopper mechanism 50 is present, the actuator 1 can be kept from becoming larger.

When a spring member is used for the first elastic member 7 which is connected to the movable element 4 and the supporting body 5 in the actuator 1, the movable element 4 may sometimes resonate at the frequency which corresponds to the mass of the movable element 4 and the spring constant of the spring member; however, in this embodiment, the gel-based damper member 70 is used for the first elastic member 7. Also, in this embodiment, only the gel-based member 70 is used for the first elastic member 7, and the gel-based damper member 70 has deformation characteristics of no spring component or little spring component depending on the deforming direction. For this reason, the movable element 4 is restricted from resonating. Also, the gel-based damper member 70 is fixed to both the movable element 4 and the supporting body 5 by a method of adhesive. Therefore, the gel-based damper member 70 is prevented from moving following the movement of the movable element 4. Accordingly, the gel-based damper member 70 can be solely used for the first elastic member 7; therefore, the configuration of the actuator 1 can be simplified. Also, the gel-based damper member 70 has a penetration from 90° to 110°. For this reason, the gel-based damper member 70 has an elasticity sufficient to demonstrate the damper function, and also will not easily be broken into pieces and scattered.

The gel-based damper member 70 deforms in the direction (the sheering direction) perpendicularly intersecting with the thickness direction (the axial direction) as the movable element 4 moves in the first direction L1 and the second direction L2. Therefore, in the actuator 1, when the movable element 4 is vibrated in the first direction L1 and in the second direction L2, the deformation characteristics in the sheering direction of the gel-based damper member 70 is used. In the deformation characteristics in the sheering direction of the gel-based damper member 70 here has more linear components than non-linear components. Therefore, in the driving direction (the first direction L1 and the second direction L2) of the actuator 1, the vibration characteristics of good linearity can be obtained.

### Major Effects of This Embodiment

As described above, in the vibration generating device 100 of this embodiment, when the movable element 4 is moved linearly back and forth by the magnetic drive circuit in each of the multiple actuators 1, the center of gravity of the actuator 1 is shifted and the vibrations are output. In this embodiment, the supporting bodies 5 used in the multiple actuators 1 are fixed to the common vibration member 110; therefore, vibrations generated in the multiple actuators 1 are transmitted to the common vibration member 110. Therefore, even when the vibration member 110 is relatively heavy, it can be vibrated with large amplitude. Further, since vibrations generated in the multiple actuators 1 are transmitted to the common vibration member 110, the movable bodies 4 in some of the multiple actuators 1 may be linearly moved back and forth in the direction different from that of the other actuators 1 so that different vibrations can be generated among the multiple actuators 1, and therefore, the common vibration member 110 can output various kinds of vibrations.

Each of the multiple actuators 1 has the first magnetic drive circuit 10 which vibrates the movable element 4 in the first direction L1 and the second magnetic drive circuit 20 which vibrates the movable element 4 in the second direction L2. For this reason, by causing different vibrations among the multiple actuators 1, the common vibration member 110 can output various kinds of vibrations.

The vibration member 110 is a plate member which extends in the first direction L1 and in the second direction L2; therefore, the vibration generating device 100 can be made thinner. Also, even when the area of the vibration member 110 is widened to increase the number of the actuators 1 which can be connected to the vibration member 110, the mass of the vibration member 110 is still small and therefore vibrations with large amplitude can be output.

Since at least three actuators of the multiple actuators are arranged to appear to be around the center position O110 of the vibration member 110 when viewed in the third direction L3 (in the Z-axis direction), vibrations generated in those multiple actuators 1 can be efficiently transmitted to the common vibration member 110; by causing different vibrations among the multiple actuators 1, the common vibration member 110 can output various kinds of vibrations.

Also, the multiple actuators 1 are arranged point symmetric about the center position O110 of the vibration member 110 and also arranged line symmetric with respect to a first imaginary line L10 and a second imaginary line L20 which pass through the center position O110 as center. For this reason, vibrations generated in the multiple actuators 1 can be efficiently transmitted to the common vibration member 110; by causing different vibrations among the multiple actuators 1, the common vibration member 110 can output various kinds of vibrations.

(Example of Another Layout of Actuators 1)

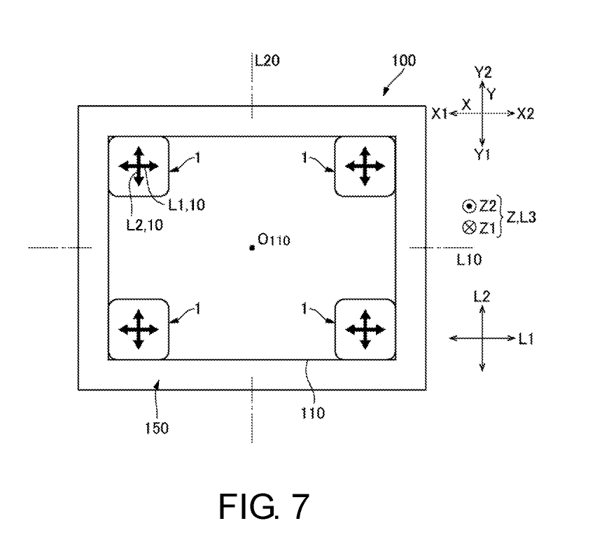

FIG. 7 is an explanatory diagram of another layout example of actuators 1 in the vibration generating device 100 to which the present invention is applied.

In the above-described embodiment, four actuators 1 are arranged near the centers of four sides of the vibration member 110; however, in this embodiment, as shown in FIG. 7, four actuators 1 are arranged at four corners of the vibration member 110. For this reason, the multiple actuators 1 are arranged point symmetric about the center position O110 of the vibration member 110. Also, the multiple actuators are arranged line symmetric with respect to the first imaginary line L10 which passes through the center position O110 of the vibration member 110 and extends in the first direction L1 (the X-axis direction) and also line symmetric with respect to the second imaginary line L20 which passes through the center position O110 of the vibration member 110 and extends in the second direction L2 (the Y-axis direction).

### Another Embodiment

In the above-described embodiment, only the gel-based damper member is used for the first elastic member 7 and the second elastic member 160; however, a spring may be used or a spring and a gel-based damper member may be used in combination for the first elastic member 7 and the second elastic member 160.

### DESCRIPTION OF REFERENCE NUMERALS

1 Actuator
4 Movable element
5 Supporting body
7 First elastic member
8 Back yoke
10 First magnetic drive circuit
110 Vibration member
11 First magnet
12 First coil
20 Second magnetic drive circuit
21 Second magnet
22 Second coil
50 Stopper mechanism
56 First casing
57 Second casing
58 Holder
70 Gel-based damper member
100 Vibration generating device
150 Stationary element
160 Second elastic member
L1 First direction
L2 Second direction
L10 First imaginary line
L20 Second imaginary line
O110 Center position

1. A vibration generating device, comprising:
a vibration member;
a plurality of actuators, connected to the vibration member; and
a stationary element which supports the vibration member via the plurality of actuators;
wherein
each of the plurality of actuators comprises:
a supporting body, to which the vibration member is fixed;
a movable element;
a first elastic member, which has at least one of elasticity and viscoelasticity, and is connected to the supporting body and the movable element, and
a magnetic drive circuit, configured to move the movable element linearly back and forth with respect to the supporting body.

2. The vibration generating device as set forth in claim 1, wherein
each of the plurality of actuators has, as the magnetic drive circuit,
a first magnetic drive circuit which moves the movable element linearly back and forth with respect to the supporting body in a first direction, and
a second magnetic drive circuit which moves the movable element linearly back and forth with respect to the supporting body in a second direction crossing the first direction.

3. The vibration generating device as set forth in claim 2, wherein
the vibration member is a plate member which extends in the first direction and in the second direction.

4. The vibration generating device as set forth in claim 2, wherein
at least three actuators of the plurality of actuators are arranged to appear to be around a center position of the vibration member when viewed in a third direction which perpendicularly intersects with the first direction and the second direction.

5. The vibration generating device as set forth in claim 4, wherein
the plurality of actuators are arranged point symmetric with the center position of the vibration member as center, or
the plurality of actuators are arranged line symmetric with respect to an imaginary line passing the center position.

6. The vibration generating device as set forth in claim 5, wherein
the plurality of actuators generate vibrations in different directions.

7. The vibration generating device as set forth in claim 6, wherein
among the plurality of actuators, the actuators which are opposed to each other having the center position therebetween, generate vibrations having opposite directionalities about the center position.

8. The vibration generating device as set forth in claim 1, wherein
the plurality of actuators are supported by the stationary element via a second elastic member which has at least one of elasticity and viscoelasticity.

9. The vibration generating device as set forth in claim 3, wherein
at least three actuators of the plurality of actuators are arranged to appear to be around a center position of the vibration member when viewed in a third direction which perpendicularly intersects with the first direction and the second direction.
